(19) United States
(12) Patent Application Publication
(10) Pub. No.: US 2008/0069268 A1
(43) Pub. Date: Mar. 20, 2008

(54) Rc Filter Pole for Fm Transmitters

(76) Inventor: John Glissman, Valley Ford, CA (US)

Correspondence Address: STAINBROOK & STAINBROOK, LLP, 412 AVIATION BOULEVARD, SUITE H, SANTA ROSA, CA, 95403, US

(21) Appl. No.: 11/658,107

(22) PCT Filed: Jul. 19, 2005
(86) PCT No.: PCT/US05/25642

§ 371 Date: Jan. 18, 2007

Related U.S. Application Data
(60) Provisional application No. 60/589,519, filed on Jul. 19, 2004.

(51) Int. Cl. H04L 27/04

(52) U.S. Cl. 375/309

(57) ABSTRACT

An RC filter pole (R1, C1) for FM transmitters converts an internal 2-pole Bessel-type filter (R1, C1, C2) on a chipset (BH141XS/F) by adding an external filter function to create a 3-pole composite filter with improved roll-off characteristics. The design methodology and specific low cost circuit implementation of the composite filter effectively minimizes the impact of signal degradation on overall link performance.

### BACKGROUND OF THE INVENTION

1. Technical Field

The present invention relates generally to FM transmitters, and more particularly to an improved RC filter pole for FM transmitters having a design methodology and specific low cost circuit implementation that effectively minimizes the impact of signal degradation on overall link performance.

2. Background Art

In the transmission of audio from Digital Audio Devices (such as MP3 players, CD players, satellite receivers, etc.) via the Commercial FM Stereo Broadcast standard, several potential sources of signal degradation exist. Examination of the typical output from these audio devices reveals that several artifacts from the sampling and reconstruction process are generated. For example, in a test on a typical digital audio device, one artifact could be seen in the range of 30 to 40 KHz. This spurious signal was only about 29 dB below the peak in-band response below 15 KHz.

As these type of devices are normally used with headphones, and even young people typically only hear frequencies up to perhaps 12-15 KHz, these artifact signals would not normally be audible. However, if these signals are used as the input to a Standard FM Stereo Broadcast Transmitter, the components in the 30-40 KHz range are in the same spectrum as the 38 KHz left-minus-right subcarrier signal used for stereo. Injecting these artifact components into the FM modulator effectively raises the noise floor, and degrades the transmitted signal-to-noise ratio in the stereo subcarrier.

When this degraded signal is processed by the stereo receiver, the poor signal-to-noise ratio of the 38 KHz subcarrier results in a noisy left-minus-right signal in the stereo decoder. When this noisy signal is added and subtracted with the left-plus-right signal to derive the stereo audio streams, this noise is added to them directly, resulting in a poor stereo signal-to-noise ratio at the receiver output. Clearly, the audio inputs to the transmitter need to be filtered above 15 KHz before the modulator to avoid these degradations.

The foregoing discussion reflects the current state of the art of which the present inventor is aware. This discussion is intended to aid in discharging Applicant's acknowledged duty of candor in disclosing information that may be relevant to the examination of claims to the present invention. However, it is respectfully submitted that there are no known patents or other references that disclose, teach, suggest, show, or otherwise render obvious, either singly or when considered in combination, the invention described and claimed herein.

### DISCLOSURE OF INVENTION

The improved RC filter pole for FM transmitters of this invention provides a design methodology and specific low cost circuit implementation of a composite filter that effectively minimizes the impact of signal degradation on overall link performance. The inventive apparatus converts an internal 2-pole Bessel-type filter on an integrated circuit chipset by adding an external filter function to create a 3-pole composite filter with improved roll-off characteristics.

It is therefore an object of the present invention to provide a new and improved composite filter for FM transmitters.

It is another object of the present invention to provide a new and improved 3-pole composite filter with improved roll-off characteristics.

A further object or feature of the present invention is a new and improved filter for a stereo broadcast transmitter chipset.

An even further object of the present invention is to provide a novel method of converting an internal 2-pole Bessel-type filter on a chipset by adding an external filter function.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the international, regional, and national patent office(s) and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a display of the output of a digital audio device while playing a test file, illustrating a sampling/reconstruction artifact in the range of 30 to 40 KHz;

FIG. 2 illustrates a computed response of a 2-pole Rohm filter of the prior art;

FIG. 3 is a model of a prior art filter on an FM transmitter integrated circuit;

FIG. 4 is a model of a 3-pole filter configuration of the present invention;

FIG. 5 illustrates the computed improved response of a 3-pole filter of the present invention; and

FIG. 6 is a display of the reduction of the noise floor of the recovered audio signals for the receiver output achieved by the RC filter pole of the present invention.

### BEST MODE FOR CARRYING OUT THE INVENTION

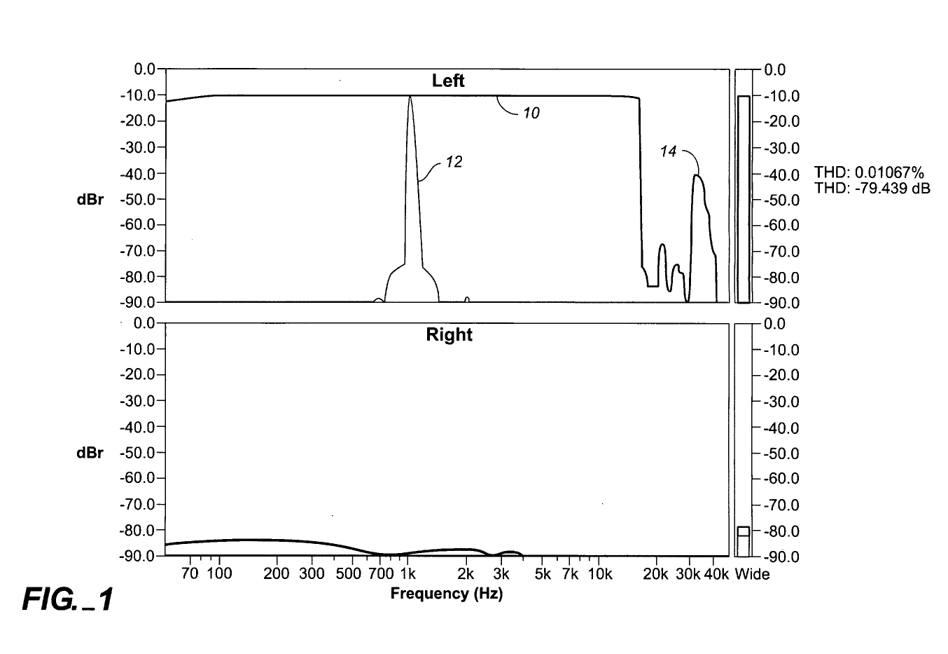

Referring to FIGS. 1 through 6, wherein like reference numerals refer to like components in the various views, FIG. 1 is a display of the output of a digital audio device while playing a computer-generated test file that generates a slowly sweeping audio tone from 20 Hz to 15 KHz on the left channel only. The trace 10 is a “max-hold” display of this swept tone at the output, while the trace 12 shows the instantaneous output when the tone was at about 1 KHz. One of the above mentioned sampling and reconstruction artifacts 14 can be seen in the range of 30 to 40 KHz on trace 10 on the left channel plot. This spurious signal is only about 29 dB below the peak in-band response below 15 KHz.

In the design of a low-powered, portable FM Stereo Broadcast Transmitter, the Rohm BH141X family of chipsets is most commonly used. These devices incorporate a pre-emphasis network, limiter, audio low-pass filter, stereo encoder, FM modulator, synthesizer, and RF amplifier on a single substrate. Although the Rohm chips incorporate a 2-pole low-pass filter, it is a Bessel function filter with very mild out-of-band attenuation characteristics. In addition, Rohm publishes a proprietary applications note on the BH141X family of chipsets that states “Please connect 150 pF of capacitors between pin 3 and GND and between pin 20 and GND. This is part of the LPF circuit and therefore the cut-off frequency is not changed even if the value is changed.” The applications note further suggests use of an external low-pass filter from Toko (P/N 388LJ-1443) in addition to two transistors and ten other passive components per channel.

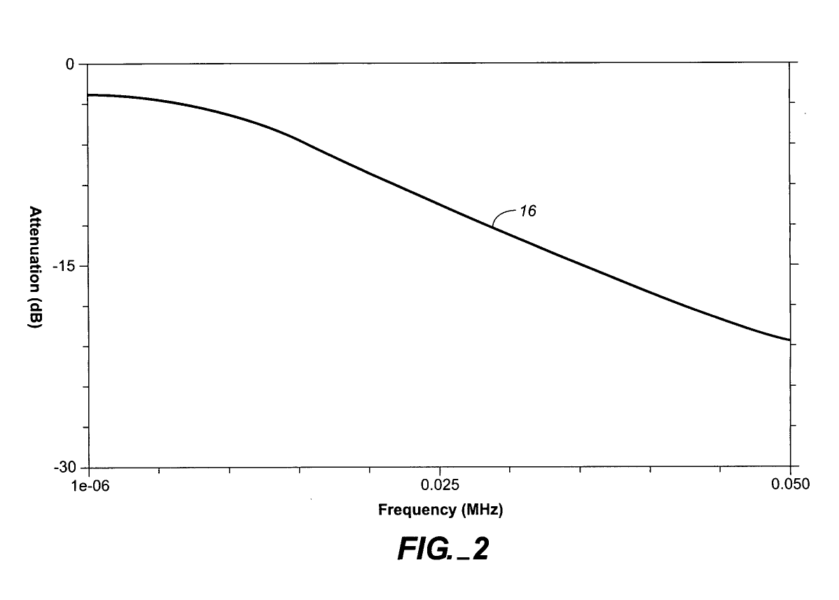

FIG. 2 illustrates a trace 16 for a computed response of frequency vs. attenuation for a 2-pole Rohm filter. This computer model of the 2-pole Rohm filter was created using their application information.

FIG. 3 is a model of the 2-pole Rohm filter. As can be seen in this model, there is an additional external RC filter pole created by resistor R1 and capacitor C1. This pole was incorporated into the design to suppress the RF from the transmitter output that is picked up on the audio input cable.

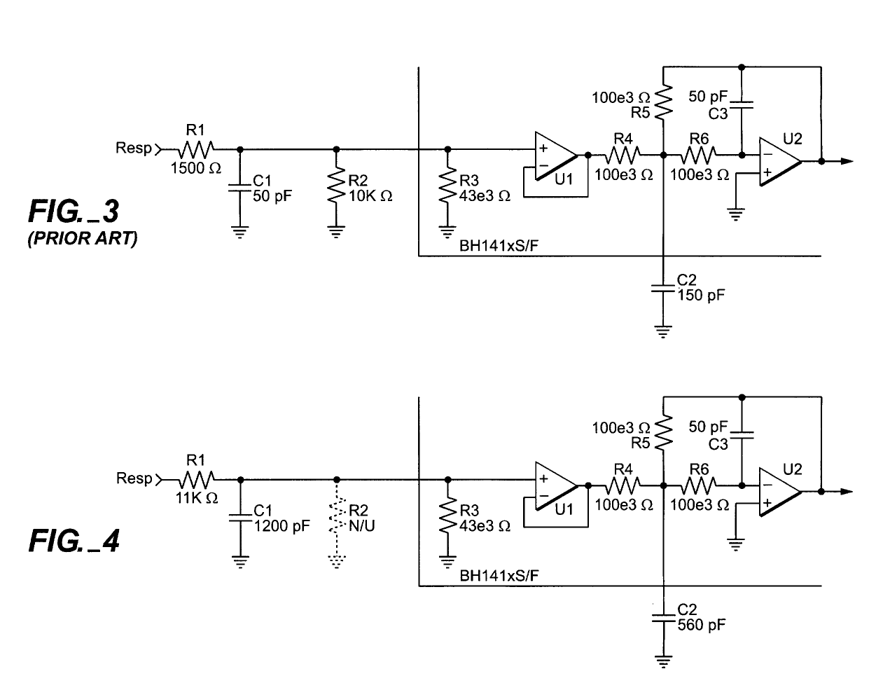

FIG. 4 is a model of a filter configuration of the present invention. As it was desirable to improve the out-of-band characteristics of the Rohm 2-pole filter, the external filter pole created by resistor R1 and capacitor C1 was lowered in frequency to create the 3rd pole of a composite 3-pole filter function. Resistor R1 was changed in value from 1500 ohms to 11K ohms, resistor R2 is not used, and capacitor C1 was changed in value from 50 pF to 1200 pF (to set the frequency of the external pole). In addition, capacitor C2 was changed in value from 150 pF to 560 pF (to set the frequency of one of the two internal poles). Here, resistors R1 and R2 and capacitors C1 and C2 are all external to the integrated circuit, and so their values can be manipulated. Alternatively, in those applications where the integrated circuit does not have an existing external filter pole topology, the inventive method provides for the creation of a third pole by incorporation of the appropriate capacitor and resistor configuration external to the chip.

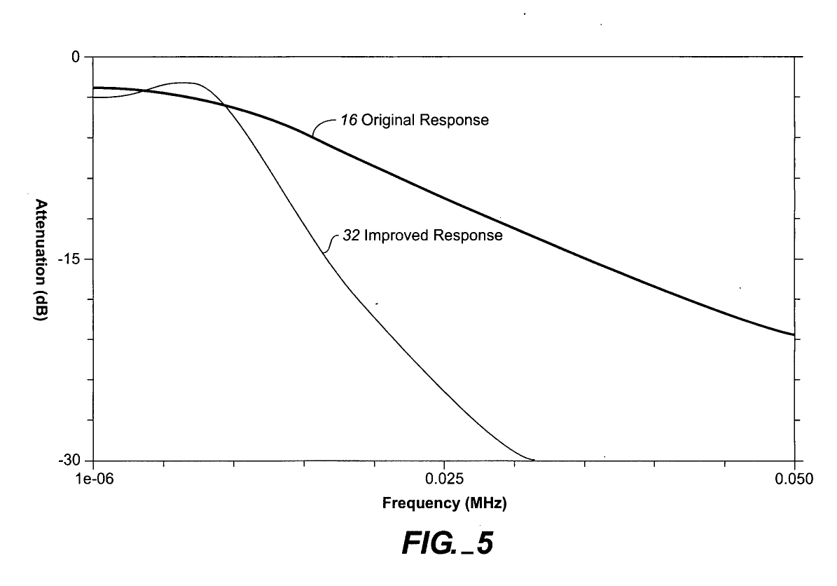

FIG. 5 illustrates the computed improved response trace 32 of a 3-pole filter of the present invention, as compared to the original response trace 16 from FIG. 2. As can be seen in FIG. 5, more than 15 dB of additional attenuation was achieved in the spectrum occupied by the 38 KHz subcarrier. This results in a greatly improved signal-to-noise ratio of the transmitted 38 KHz subcarrier.

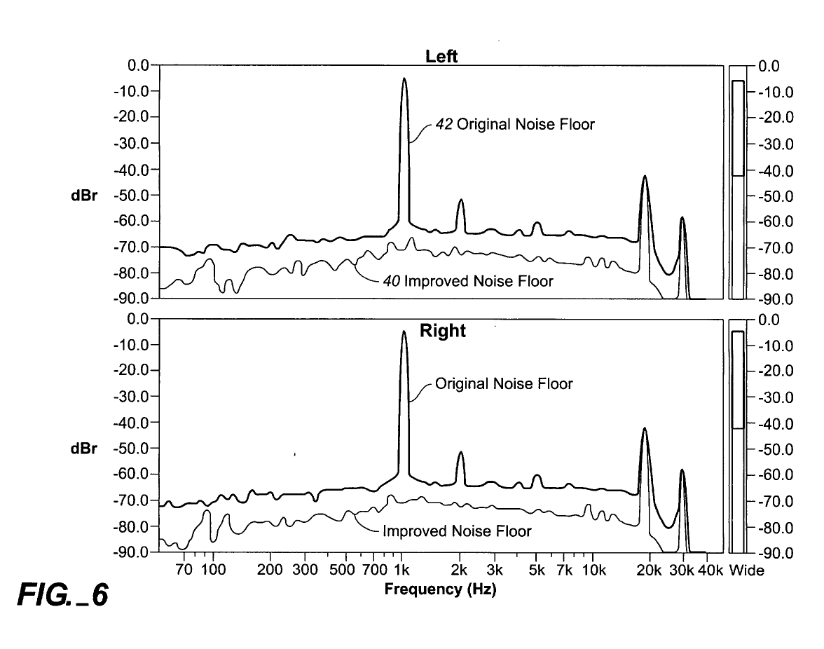

The effect of this reduction in transmitter noise can be seen in FIG. 6 as the reduction of the left channel noise floor of the recovered audio signals from the receiver output. Improved noise floor trace 40 shows improvement over original noise floor trace 42 over essentially the entire spectrum. The changing of two capacitor values (C1 and C2), one resistor value (R1), and the elimination of one resistor (R2) in each channel achieved these improvements, and have been tested on Rohm's BH1415F, BH1416F, BH1417F and BH1418F FM Transmitter Integrated Circuits. The inventive modification may also be applied to future low-current designs for the BH14XX family of chipsets, as well as other comparable or alternative chipsets from Rohm or other manufacturers.

The inventive technique can also be applied to other FM transmitter circuits to improve signal-to-noise ratio, and such techniques would be a low-cost solution which otherwise would require many more external parts.

Accordingly, the present invention may be characterized as a method for reducing signal degradation in an FM stereo broadcast transmitter integrated circuit having a two-pole low-pass filter and an external filter pole comprising a resistor and capacitor, the method comprising the steps of creating a third pole of a composite 3-pole filter function by lowering the frequency of the external filter pole on the integrated circuit.

Alternatively, the present invention may be characterized as method for reducing signal degradation in an FM stereo broadcast transmitter integrated circuit having a two-pole low-pass filter, the method comprising the steps of creating a third pole of a composite 3-pole filter function by incorporation of the appropriate capacitor and resistor configuration external to the integrated circuit, for those applications where the integrated circuit does not have an existing external filter pole topology.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A method for reducing signal degradation in an FM stereo broadcast transmitter integrated circuit, the integrated circuit having a two-pole low-pass filter and an external filter pole comprising a resistor and capacitor, said method comprising the steps of:
creating a third pole of a composite 3-pole filter function by lowering the frequency of the external filter pole on the integrated circuit.

2. The method for reducing signal degradation in an FM stereo broadcast transmitter integrated circuit of claim 1 wherein said step of lowering the frequency of the external filter pole comprises changing the value of the resistor.

3. The method for reducing signal degradation in an FM stereo broadcast transmitter integrated circuit of claim 2 wherein said step of lowering the frequency of the external filter pole comprises changing the value of the resistor from approximately 1500 ohms to 11K ohms.

4. The method for reducing signal degradation in an FM stereo broadcast transmitter integrated circuit of claim 1 wherein said step of lowering the frequency of the external filter pole comprises changing the value of the capacitor.

5. The method for reducing signal degradation in an FM stereo broadcast transmitter integrated circuit of claim 4 wherein said step of lowering the frequency of the external filter pole comprises changing the value of the capacitor from approximately 50 pF to 1200 pF.

6. The method for reducing signal degradation in an FM stereo broadcast transmitter integrated circuit of claim 1 wherein said FM stereo broadcast transmitter integrated circuit includes a pair of channels, and said method includes creating a third pole of a composite 3-pole filter function by lowering the frequency of the external filter pole on the integrated circuit for each of the channels.

7. The method for reducing signal degradation in an FM stereo broadcast transmitter integrated circuit of claim 1 wherein said integrated circuit external filter pole comprises a second resistor, and said step of lowering the frequency of the external filter pole comprises disconnecting the second resistor.

8. The method for reducing signal degradation in an FM stereo broadcast transmitter integrated circuit of claim 1 wherein said integrated circuit external filter pole comprises a second capacitor, and said step of lowering the frequency of the external filter pole comprises changing the value of the second capacitor.

9. The method for reducing signal degradation in an FM stereo broadcast transmitter integrated circuit of claim 8 wherein said integrated circuit external filter pole comprises a second capacitor, and said step of lowering the frequency of the external filter pole comprises changing the value of the second capacitor from approximately 150 pF to 560 pF.

10. A method for reducing signal degradation in an FM stereo broadcast transmitter integrated circuit, the integrated circuit having a two-pole low-pass filter, said method comprising the steps of:
creating a third pole of a composite 3-pole filter function by incorporation of the appropriate capacitor and resistor configuration external to the integrated circuit.
